(19) United States
(12) Patent Application Publication
(10) Pub. No.: US 2004/0240689 A1
(43) Pub. Date: Dec. 2, 2004

(54) Electronic apparatus

(75) Inventor: Tomofumi Miyamoto, Nishitama-gun (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/814,296

(22) Filed: Apr. 1, 2004

(30) Foreign Application Priority Data
May 30, 2003 (JP) 2003-155475

(51) Int. Cl. H04R 5/02; H04R 1/02; H04R 9/06

(52) U.S. Cl. 381/306; 381/333; 381/388; 381/349

(57) ABSTRACT

A speaker unit is arranged in a casing of an electronic apparatus. The speaker unit includes a cabinet, a speaker arranged in the cabinet and exposed to the outside of the cabinet, and a port which is defined in the cabinet to open the outside of the cabinet and through which a sound emitted from the backside of the speaker into the cabinet is radiated outward from the cabinet. The speaker is exposed to the outside of the casing through an opening defined in an outside wall of the casing. The port of the speaker unit opens into the casing.

### CROSS-REFERENCE TO RELATED APPLICATIONS

This application is based upon and claims the benefit of priority from prior Japanese Patent Application No. 2003-155475, filed May 30, 2003, the entire contents of which are incorporated herein by reference.

### BACKGROUND OF THE INVENTION

1. Field of the Invention

The present invention relates to electronic apparatuses, such as personal computers, and more particularly, to an electronic apparatus having speaker units for sound reproduction therein.

2. Description of the Related Art

Portable electronic apparatuses that are represented by notebook-sized portable computers and mobile communication equipments, such as the one described in U.S. Pat. No. 5,682,290, comprise a casing and a speaker unit for sound reproduction in the casing. Recently, chances of reproducing music or watching images, such as movies, by portable electronic apparatuses have been increasing with the advance of CD drives, DVD drives, etc. Accordingly, there is a demand for the development of high-performance built-in speaker units that ensure high tone quality.

A modern speaker unit disclosed in U.S. Pat. No. 5,610,992 is a so-called bass-reflex speaker unit that has high bass reproducing capability. In general, the bass-reflex speaker unit has an independent speaker box, i.e., a cabinet, a speaker attached to the front face of the cabinet, a port for bass reflex, and a duct or acoustic tube. The port opens in the front face of the cabinet. The acoustic tube communicates with the port and is located in the cabinet. A sound that is radiated from the back of the speaker into the cabinet is partially emitted from the port in phase with a sound that is radiated from the front face of the speaker. Thus, the bass range can be enhanced to reproduce rich low-pitched sounds or voices.

If the speaker unit constructed in this manner is incorporated in a portable computer, for example, the whole cabinet is located in the casing of the computer. The outer surface of the casing is provided with an opening that faces the speaker of the speaker unit and an opening that faces the bass-reflex port. Those parts of the cabinet which are provided individually with the speaker and the port are exposed to the outside through the openings in the casing of the computer, and partially form the outer surface of the casing.

If the bass-reflex speaker unit is thus incorporated in the electronic apparatus, the speaker and the bass-reflex port are exposed outward from the casing of the electronic apparatus. In designing the speaker unit, therefore, the layout of the port and the duct that extends from the port is restricted inevitably. Since those parts of the cabinet which are provided individually with the speaker and the port partially form the outer surface of the casing of the electronic apparatus, moreover, the shape of the cabinet and the like are restricted. Thus, it is hard and takes a lot of time to develop cabinets that fit electronic apparatuses.

Normally, a pair of speaker units are arranged bilaterally. In order to enjoy high bass-range tone quality, the respective cabinets of the two speaker units should preferably have an ideal volume. However, various electronic components are arranged in the casing of a modern electronic apparatus, and the setting space for the speaker units is limited. In some cases, therefore, it is hard to design the bilateral cabinets with the same volume. If the paired cabinets have different volumes, low-pitched sounds that are outputted from the opposite sides are unbalanced and offensive to the ear.

### BRIEF SUMMARY OF THE INVENTION

According to an aspect of the invention, an electronic apparatus comprises a casing and a speaker unit located in the casing, the speaker unit including a cabinet, a speaker located exposed in the cabinet, and a port which opens in the cabinet and through which a sound emitted from the backside of the speaker is radiated outward from the cabinet, the speaker being exposed to the outside of the speaker unit through an opening defined in the outside wall of the casing, the port opening into the casing.

Further, an electronic apparatus according to another aspect of the invention comprises a casing and a pair of speaker units, left and right, located in the casing, each of the speaker units including a cabinet, a speaker located exposed in the cabinet, and a port which opens in the cabinet and through which a sound emitted from the backside of the speaker is radiated outward from the cabinet, the speaker being exposed to the outside of the speaker unit through an opening defined in the outside wall of the casing, the port opening into the casing.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a portable computer according to a first embodiment of the invention;

FIG. 2 is a plan view showing the interior of the body of the portable computer;

FIG. 3 is a plan view showing the bottom of the computer body;

FIG. 4 is an exploded perspective view showing the rear end portion of the body of the portable computer and speaker units;

FIG. 5 is an exploded perspective view showing the rear end portion of the computer body and the speaker units;

FIG. 6 is a perspective view showing one of the speaker units;

FIG. 7 is a perspective view showing the other speaker unit;

FIG. 8 is a sectional view showing the rear end portion of the computer body;

FIG. 9 is a sectional view showing the rear end portion of the computer body and the speaker units;

FIG. 10 is an exploded perspective view showing the rear end portion of the body of a portable computer according to a second embodiment and speaker units; and

FIG. 11 is a plan view showing the interior of the body of the portable computer according to the second embodiment.

### DETAILED DESCRIPTION OF THE INVENTION

A portable computer as an electronic apparatus according to a first embodiment of the present invention will now be described in detail with reference to the accompanying drawings.

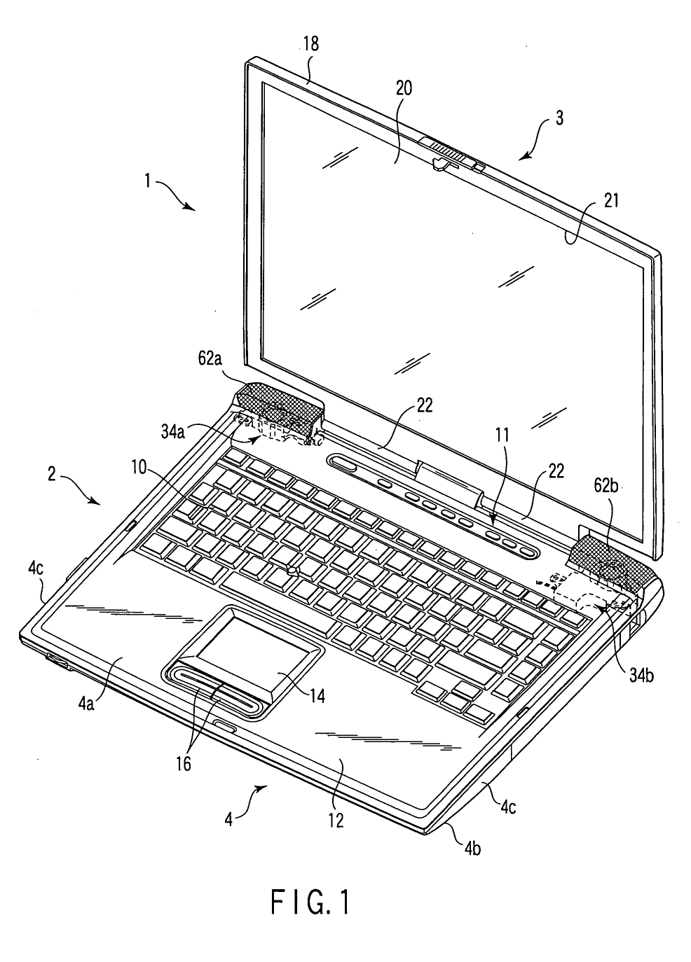

As shown in FIG. 1, a portable computer 1 comprises a computer body 2 and a display unit 3 that is supported on the body 2. The computer body 2 is provided with a casing 4 that is formed of synthetic resin, for example. The casing 4 is in the form of a flat box, which has a top wall 4a, bottom wall 4b, left- and right-hand sidewalls 4c, front wall 4d, and rear wall 4e. A keyboard 10 is provided on the central portion of the top wall 4a, and various indicators 11 are arranged on the rear end portion of the top wall. The front end portion of the top wall 4a forms a palm rest portion 12, and a touch pad 14 and click buttons 16 are arranged substantially in the center of the palm rest portion.

The display unit 3 is provided with a housing 18 in the form of a flat rectangular box and a liquid crystal display panel 20 located in the housing. The panel 20 is exposed to the outside through a display window 21 in the housing 18. The housing 18 has a pair of leg portions 22 that protrude from its one end portion. These leg portions 22 are rockably supported on the rear end portion of the casing 4 by means of hinge portions (not shown). Thus, the display unit 3 is rockable between a closed position in which it is flattened to cover the keyboard 10 from above and an open position in which it stands upright at the back of the keyboard 10.

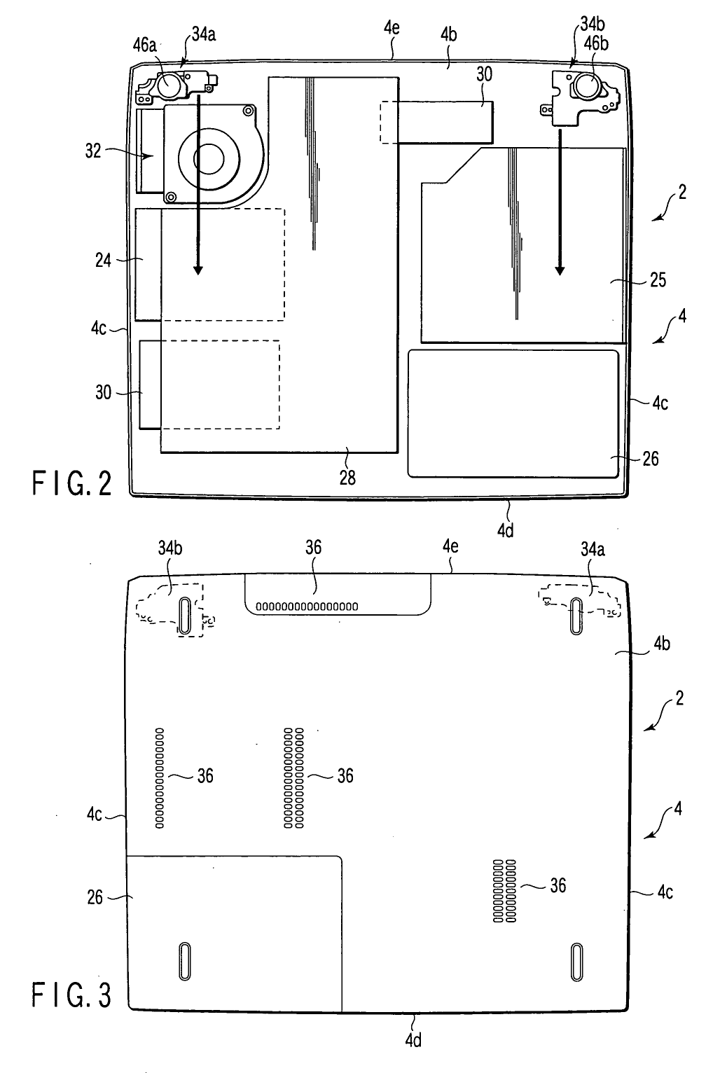

As shown in FIG. 2, the casing 4 of the computer body 2 contains a hard disc drive 24, an optical disc drive 25, such as a CD or DVD, a battery 26, a main printed circuit board 28, sub-printed circuit boards 30, and various other electronic components. Further, a cooling unit 32 having a cooling fan, heat pipe, etc. is located in the casing 4. A pair of speaker units 34a and 34b are arranged in the rear end portion of the casing 4. They are spaced in the width direction of the casing 4. As shown in FIG. 3, air inlets 36 through which cooling air is sucked into the casing 4 are defined in the bottom wall 4b of the casing.

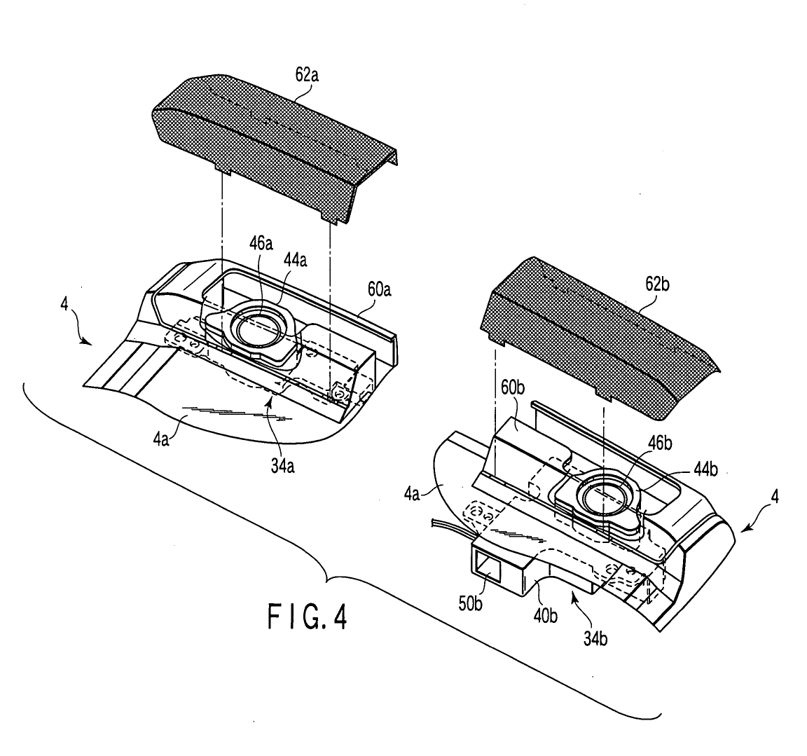

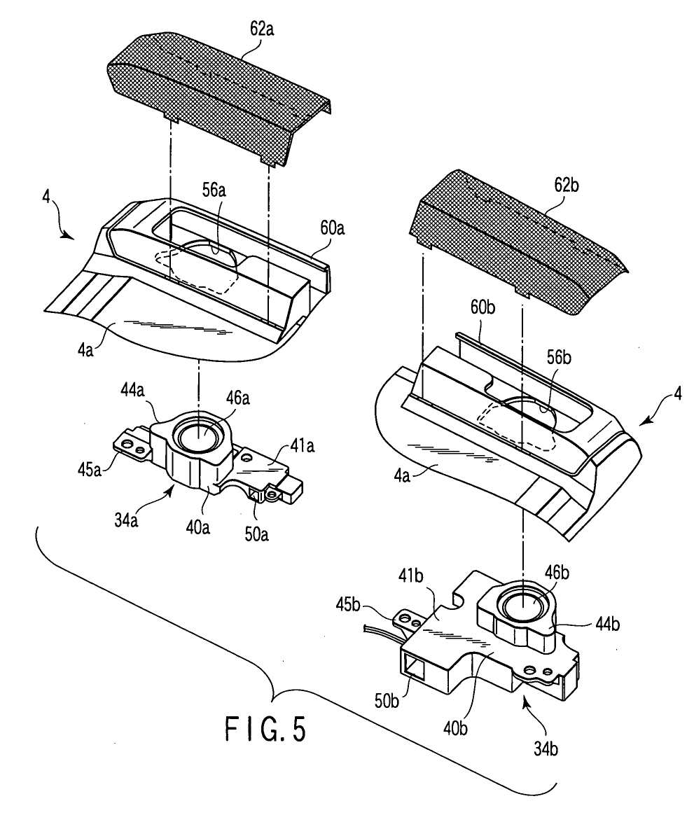

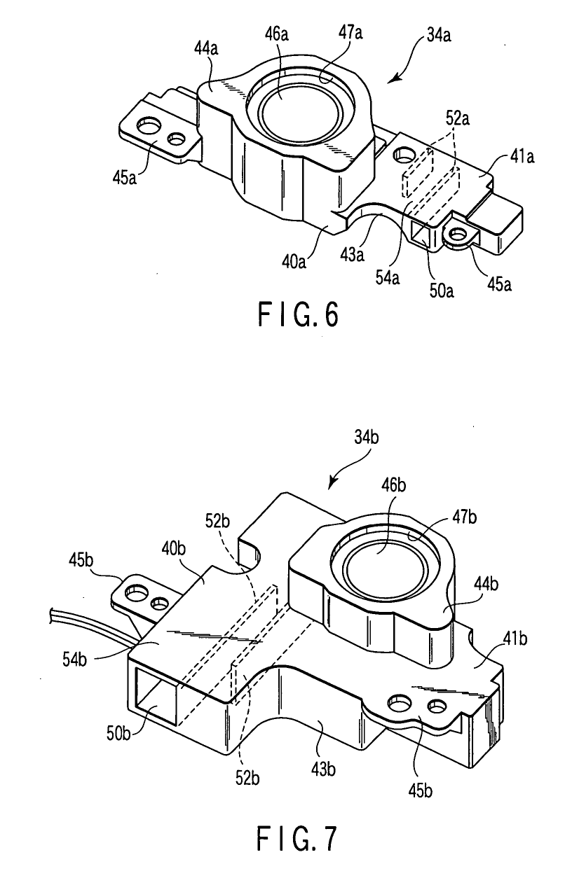

The following is a detailed description of the speaker units 34a and 34b that are arranged in the casing 4. As shown in FIGS. 4, 5, 6, 8 and 9, the speaker unit 34a is provided with a speaker box or hollow cabinet 40a formed of synthetic resin, for example, and a speaker 46a in the cabinet. The cabinet 40a is a substantially flat rectangular structure, which has flat top and bottom faces 41a and 42a and side faces 43a. The cabinet 40a has a hollow protrusion 44a that protrudes upward from the central part of the top face 41a. The speaker 46a is situated in the protrusion 44a in the cabinet 40a. The front face of a diaphragm 48a that constitutes the speaker 46a is exposed outward from the cabinet 40a through an aperture 47a in the projected end of the protrusion 44a. The cabinet 40a is formed integrally with brackets 45a that are used to screw down the speaker unit 34a.

The speaker unit 34a is of the bass-reflex type. A port 50a for bass reflex is defined in any of other outer surfaces of the cabinet 40a than the top face 41a. In this case, the port 50a is defined in one of the side faces 43a of the cabinet 40a. An acoustic tube or duct is defined in the cabinet 40a by partition walls 52a. The duct defines a passage 54a that communicates with the port 50a. A sound that is emitted from the back of the speaker 46a into the cabinet 40a partially passes through the passage 54a and is radiated from the port 50a in phase with a sound that is emitted from the front of the speaker.

As shown in FIGS. 7 to 9, the other speaker unit 34b is constructed in the same manner as the speaker unit 34a. Like reference numerals with different subscripts a and b are used to designate like components of the speaker units 34a and 34b, respectively, and a detailed description of those components will not be repeated. A cabinet 40b of the speaker unit 34b is larger in capacity than the cabinet 40a of the speaker unit 34a.

The speaker units 34a and 34b constructed in this manner are located in the rear end portion of the casing 4 and fixedly screwed to the inner surface of the top wall 4a of the casing 4. As shown in FIGS. 4, 5, 8 and 9, openings 56a and 56b are defined individually in the two corner portions of the top wall 4a of the casing 4 on its rear end side. The speakers of the speaker units 34a and 34b are exposed through the openings 56a and 56b. The openings 56a and 56b are shaped corresponding to the respective cross sections of protrusions 44a and 44b on the cabinets 40a and 40b of the speaker units 34a and 34b. The speaker units 34a and 34b are screwed to the top wall 4a with the protrusions 44a and 44b of the cabinets 40a and 40b passed through the openings 56a and 56b, respectively, and with the top faces 41a and 41b of the cabinets intimately in contact with the inner surface of the top wall 4a of the casing 4.

Thus, the respective speakers 46a and 46b of the speaker units 34a and 34b are exposed outward from the casing 4 through the openings 56a and 56b of the casing. Further, ports 50a and 50b in the cabinets 40a and 40b open into the casing 4. The ports 50a and 50b open in the same direction. In the present embodiment, they open toward the front end portion of the casing 4.

Partition walls 60a and 60b are set up integrally on the top wall 4a of the casing 4 so as to surround the openings 56a and 56b, respectively. Further, the top wall 4a is fitted with protective nets 62a and 62b, which cover the partition walls 60a and 60b and the openings 56a and 56b, respectively.

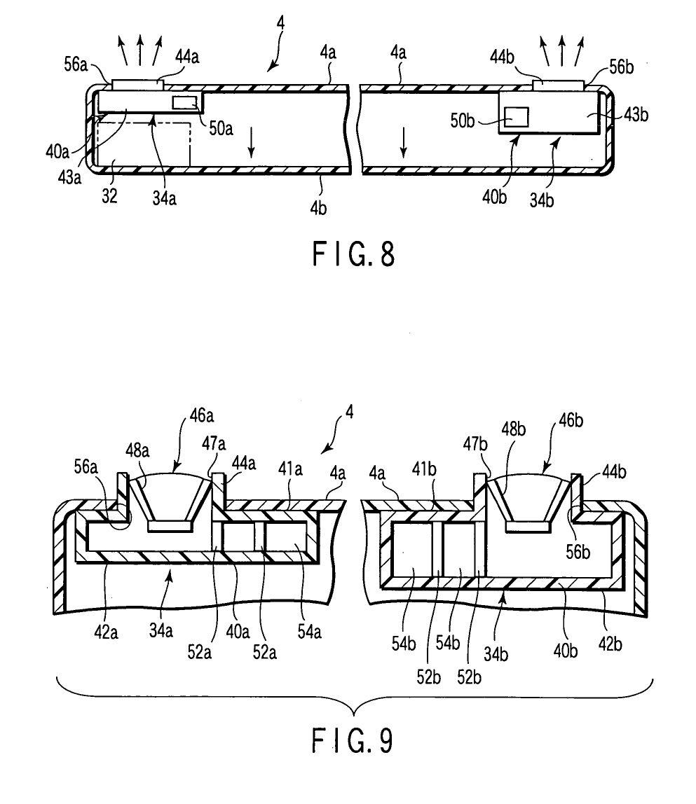

When the speaker units 34a and 34b are worked, as shown in FIGS. 2 and 8, high-, medium-, and low-pitched sounds that are emitted from the front side of the speakers 46a and 46b radiated directly outward from the casing 4. On the other hand, low-pitched sounds that are emitted from the backside of the speakers 46a and 46b into the cabinets 40a and 40b are radiated from the ports 50a and 50b into the casing 4 in phase with the sounds emitted from the front of the speakers. Since low-pitched sounds are low in directivity, the low-pitched sounds that are emitted from the speaker units 34a and 34b into the casing 4 are synthesized together. The resultant sound vibrates the whole casing 4 and is partially radiated to the outside of the casing through the air inlets 36 in the bottom wall 4b of the casing and various gaps. Thus, the bass range can be enhanced to reproduce rich low-pitched sounds or voices.

According to the portable computer constructed in this manner, the bass-reflex speaker units 34a and 34b are located in the casing 4 of the computer body 2, and their speakers 46a and 46b are exposed outward from the casing through the openings 56a and 56b. The bass-reflex ports 50a and 50b in the cabinets 40a and 40b open into the casing 4 without being exposed in the outer surface of the casing. In designing the speaker units 34a and 34b, therefore, the ports 50a and 50b and the ducts that extend from them can be arranged freely, so that the degree of freedom of design can be heightened considerably. Further, the outer surface of the casing 4 need not be formed partially of those parts of the cabinets 40a and 40b in which the ports 50a and 50b are defined, so that restrictions on the shape and the like in the design of the cabinets can be reduced. Thus, cabinets that are adapted for portable computers can be developed easily in a short period of time.

In the embodiment described above, the speaker unit 34a is located overlapping the cooling unit 32, so that its cabinet 40a is made smaller than the cabinet 40b of the other speaker unit 34b. Thus, the cabinets 40a and 40b are different in capacity. As mentioned before, however, the ports 50a and 50b of the cabinets 40a and 40b open into the casing 4, and the low-pitched sounds are radiated from these ports into the casing. The radiated low-pitched sounds are low in directivity, and a user can hear the resultant sound created in the casing 4 substantially from the central portion of the casing 4. If the respective cabinets 40a and 40b of the opposite speaker units 34a and 34b are different in capacity, therefore, a feeling of imbalance between the low-pitched sounds can be lessened. Accordingly, the cabinets 40a and 40b of the speaker units 34a and 34b can be designed having different sizes and capacities, depending on the conditions of layout in the casing 4 and the like. In consequence, the degree of freedom of the design of the speaker units can be heightened further.

Thus, there may be obtained a portable computer of which the design of the speaker units enjoys a high degree of freedom and which can reproduce sounds of high tone quality.

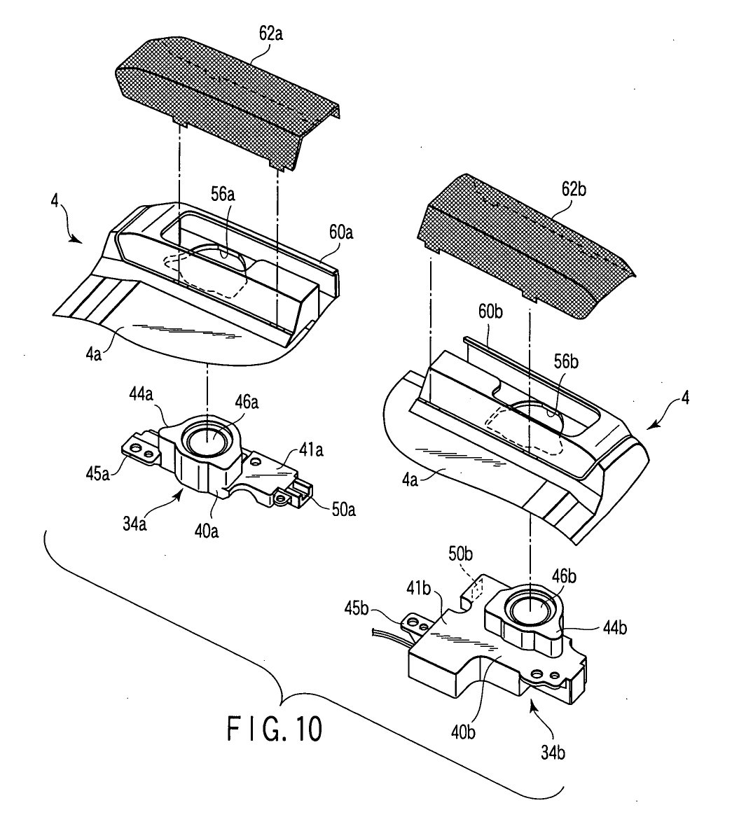

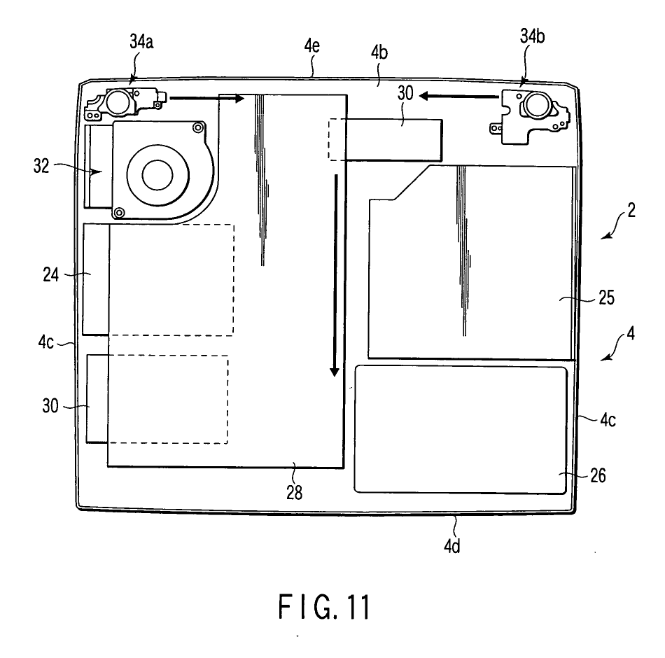

In the embodiment described above, the ports in the respective cabinets of the speaker units open forward into the casing 4. However, these ports are expected only to open into the casing, and their direction can be changed variously. According to a second embodiment shown in FIGS. 10 and 11, for example, ports 50a and 50b of speaker units 34a and 34b that are arranged left and right open opposite to each other, that is, inward in the width direction of the casing 4. The second embodiment shares other configurations with the foregoing embodiment. Therefore, like reference numerals are used to designate like portions of these embodiments, and a detailed description of those portions is omitted.

Also with this arrangement, low-pitched sounds that are radiated from the ports 50a and 50b of the cabinets 40a and 40b into the casing 4 can be synthesized in the casing and heard substantially from the central portion of the casing by the user. Thus, the same functions and effects of the foregoing first embodiment can be obtained.

Further, the present invention is not limited to portable computers, and may be also applied to some other electronic apparatuses, such as a PDA (personal digital assistant). Furthermore, the number of speaker units is not limited to two, and may be one or three or more. Although the speakers of the speaker units are exposed in the top wall of the casing according to the foregoing embodiments, moreover, they may alternatively be exposed in any other outer surfaces, such as the sidewalls, bottom wall, etc.

What is claimed is:

1. An electronic apparatus comprising:
a casing; and
a speaker unit located in the casing,
the speaker unit including a cabinet, a speaker arranged in the cabinet and exposed to the outside of the cabinet, and a port which is defined in the cabinet to open the outside of the cabinet and through which a sound emitted from the backside of the speaker into the cabinet is radiated outward from the cabinet,
the speaker being exposed to the outside of the casing through an opening defined in an outside wall of the casing, and the port of the speaker unit opening into the casing.

2. An electronic apparatus according to claim 1, wherein the cabinet has a top face in contact with an inner surface of the outside wall of the casing and a protrusion protruding from the top face and passed through the opening in the outside wall, and the speaker is located in the cabinet so as to be exposed to the protrusion.

3. An electronic apparatus according to claim 1, which further comprises a display unit having a display panel and connected to the casing, and a keyboard attached to the casing.

4. An electronic apparatus comprising:
a casing; and
a pair of speaker units, left and right, located in the casing, each of the speaker units including a cabinet, a speaker arranged in the cabinet and exposed to the outside of the cabinet, and a port which is defined in the cabinet to open the outside of the cabinet and through which a sound emitted from the backside of the speaker into the cabinet is radiated outward from the cabinet,
the speaker being exposed to the outside of the casing through an opening defined in an outside wall of the casing, and the port of the speaker unit opening into the casing.

5. An electronic apparatus according to claim 4, wherein the respective cabinets of the speaker units have different capacities.

6. An electronic apparatus according to claim 4, wherein the speaker units are arranged in the casing with the respective ports thereof opposed to each other.

7. An electronic apparatus according to claim 4, wherein the speaker units are arranged in the casing with the respective ports thereof oriented in the same direction.

8. An electronic apparatus according to claim 4, wherein the cabinet of each speaker unit has a top face in contact with an inner surface of the outside wall and a protrusion protruding from the top face and passed through the opening in the outside wall, and the speaker is located in the cabinet so as to be exposed to the protrusion.

9. An electronic apparatus according to claim 4, which further comprises a display unit having a display panel and connected to the casing, and a keyboard attached to the casing.
